(19) United States
(12) Patent Application Publication
(10) Pub. No.: US 2002/0139071 A1
(43) Pub. Date: Oct. 3, 2002

(54) Composite climate seal frame member assembly and method of manufacturing

(76) Inventor: Dennis Banford, Alpharetta, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/825,193

(22) Filed: Apr. 3, 2001

(51) Int. Cl. E06B 1/04; E04C 2/38

(52) U.S. Cl. 52/204.1; 52/656.2

(57) ABSTRACT

A climate seal frame member assembly for constructing a frame around an ingress/egress door to a structure. The assembly includes an elongate, two-part member where one part is extruded from a foamed PVC material and the other part is milled from an elongate piece of lumber. The PVC member is exposed to the outdoor environment when installed, and the milled wood part, isolated from the outdoor weather by a weather-strip, provides a wooden surface for receiving paint or stain. The cross sectional shape of the PVC part is extruded to incorporate a door stop and a tongue for engaging with a matching grove milled into the wooden part. The system is formed by extruding the PVC member, milling the lumber, applying an adhesive where the PVC member joins the wooden member, joining the parts along the edges having adhesive, and nailing the two members together.

### FIELD OF THE INVENTION

The present invention is directed to a doorframe assembly, and, more particularly to a two piece doorframe wherein one piece is made from a weather resistant material, such as foamed polyvinyl chloride, the other piece is made from wood, and the two pieces mate with an interlocking joint.

### BACKGROUND

In the residential housing industry, as in the commercial building industry, it is desirable to use durable building materials while at the same time keeping costs low. However, economics, especially in the residential context place an even higher emphasis on keeping costs low than in the commercial context. Therefore, wood is used as the primary building material in the residential housing industry because wood is relatively inexpensive, easy for carpenters to work with and generally found in plentiful supply.

However, due to the vulnerable nature of wood vis-á-vis its environment, such as weather and ultraviolet light from the sun, other materials must be used to protect wooden materials from environmental forces. Thus, paint and shingles, among other materials, are used to extend the life span of the wooden materials. Indeed, through careful use and maintenance of such other materials, the life span of wood may be extended indefinitely. However, if the protecting materials are not carefully applied to the wood, undesirable effects may occur. These effects include warping of the wood due to moisture from rain and humidity, rot and destruction due to termite infestation. In other words, if the surfaces of wood building products are not properly protected from environmental factors, the durability and longevity of the material may be degraded significantly. This may occur although the surfaces of the wood are not directly exposed to environmental elements.

Even though the wood surfaces are not directly facing the weather or sunlight, the surface may nevertheless be exposed to destructive environmental factors where a surface of one material abuts the surface of another, where the surfaces do not perfectly match. Thus, moisture and parasites such as termites may attack the wood and destroy it. This destruction often occurs in the wood used to construct external doorframes around doors that provide ingress and egress between the interior and the exterior of a structure. Often, a structure's siding may be made of a material having a rough, uneven surface, such as brick or stucco. When these materials are used, the doorframe does not fit so as to prevent rain and other weather elements from accumulating between the frame and siding. Thus, moisture may enter the gaps and spaces and accumulate between the siding and the doorframe, creating a condition that may accelerate the degradation of the door frame material or the siding material. Even when the gaps are filled with material such as caulk, the caulk tends to shrink over time, thereby creating an undesirable appearance and allowing moisture to build up between the siding and the framing member. Since houses are usually built first and then painted, the surfaces of the framing member that face the space between the member and the siding typically are not painted. Thus, when this framing member is made from wood, it is typically only a matter of time before rot or termites begin to destroy a wooden framing member.

There have been several attempts in the past to alleviate the problems of environmental susceptibility mentioned above. For instance, related art U.S. Pat. No. 3,591,985 to Coppins relates to an apparatus where the wooden door frame components are sheathed in a thin plastic material. This allegedly alleviates the problem of environmental degradation, but the decorative effect may not be desirable, since many homeowners prefer the look of real wood, especially on interior trim surfaces. Moreover, the sheathing is easily pierced, scratched and otherwise damaged. Furthermore, the sheathing may fade in color or buckle and wrinkle due to environmental conditions such as heat and ultraviolet rays from sunlight.

Another attempt disclosed in related art U.S. Pat. No. 5,758,458 to Ridge shows a wood and vinyl hybrid door frame. Vinyl channel portions of the frame are alleged to provide protection from environmental effects, but also provide decorative functionality as well as providing a door stop function. The invention uses hollow vinyl moldings that are tacked or stapled onto the wooden support panel. Although the support panel is wooden, it does not appear the wood panel is meant to provide any decorative purpose, but is meant to merely provide a base to which door hinges and the vinyl channel members may be attached.

In related art shown in U.S. Pat. No.'s 5,634,303; 5,901,510; and 6,148,582 to Ellingson, a door jamb assembly is disclosed that uses an extruded plastic member and a wooden member. This family of patents teach that the extruded member provides protection against environmental effects, while the wooden member provides a natural look and allows nailing or screwing, such that a door may be hung to the assembly in traditional fashion. The third Ellingson patent discloses forming a dado or rectangular groove or recess in the wooden member for receiving and engaging a protrusion from the extruded member. Nevertheless, the Ellingson family of patents teaches away from the need for milling the wooden member.

The above-disclosed patents show the use of fasteners such as staples, nails, or brads. The patent to Ridge also mentions using an adhesive to attach flat fins of the molded channels to the wood panel, but the adhesive does not work in cooperation with a structural device such as a rabbet or a tongue and groove joint.

None of the referenced art discloses using a wooden member that has been milled to form a structural mating joint or that may have decorative features that appear as traditional millwork. Thus, there is a need in the related art for a composite framing member assembly that provides the weather resistant characteristics of plastic where the member is exposed to weather and that provides the desirable aesthetic qualities of wood where the member is apparent from the interior of a structure in which it is installed.

Furthermore, there is a need for a composite framing assembly where separate components are joined together such that the framing assembly is inherently structurally solid as contrasted with a framing member where the discrete components are merely joined by nails, brad or staples.

Additionally, there is a need in the related art for such a framing member that is relatively easy to install in terms of man-hours required. Moreover, homeowners want the materials used in the construction of their home to resemble high quality traditional materials as much as possible. Thus, there is also a need in the art for a framing member made from materials that are capable of receiving paint and other such coatings, but that are resistant to flaking and chipping of such coatings, and furthermore do not cause an applied material to fade and discolor.

Finally, there is a need in the art for a composite framing member that hides any sealing material such as caulk.

### SUMMARY OF THE INVENTION

The present invention meets the needs felt in the related art. The present invention provides a composite framing member assembly that is easy to use by craftsmen, that can be fashioned in the field in a manner similar to that used when a frame is fashioned from a single wooden member, either milled or non-milled.

In the preferred embodiment of the present invention, the framing member comprises two individual members that have been joined at a milling factory from an elongated plastic member and an elongated milled wooden member. The plastic material used is blown polyvinyl chloride (“PVC”) which is a material known to those skilled in the art of building materials. The wooden member is an elongated member made from lumber that may be milled to form an interlocking joint, such as a tongue-and-groove joint, and any other decorative molding that may be desired.

One advantage of the present invention is the weather resistant properties of the external PVC. The present invention alleviates problems that occur when wooden surfaces are exposed to weather elements. The PVC portion is the portion that is exposed to exterior weather conditions and thus bears the brunt of the damaging effects of rain, sunlight, wind, heat, etc. Therefore, because of the weather resistant properties of PVC, the composite framing member assembly is resistant to conditions that tend to destroy wooden frame members, or require periodic maintenance, such as painting and caulking, to prevent such destruction.

In addition to the weather resistance of the exterior portion, the composite assembly has the desirable advantage of providing a wooden interior portion. Thus, the appearance of the interior portion may be painted or stained and have the appearance of a traditional wood framing trim member. Furthermore, the material used for the external member provides a suitably adherent surface for receiving paint.

In addition, the composite assembly functions as a singular member. This is achieved by the manner in which the separate components are joined together. Unlike other framing members that use staples, brads, nails, or other such fastening method, the preferred embodiment of the present invention uses a tongue-and-groove joint in conjunction with an adhesive to ensure that the joined components form a structurally solid unitary composite framing assembly.

A further advantage of the preferred embodiment is provided by the extent of the PVC portion that forms a stop shoulder extending from the exposed face of the joined framing member. This shoulder acts as a stop and is formed to include a groove between the stop and the wooden portion for receiving a weather strip. As a result, the location of the weather-strip ensures that the wooden portion will be isolated from the outdoor elements such as weather and sunlight. Therefore, the wood portion may be covered with typical interior coatings such as paint or stain, or even left bare if the owner desires, with no susceptibility to the outdoor elements. It will be appreciated that while the preferred embodiment includes a stop, the advantages of the present invention may be realized without a stop formed in the PVC portion.

Yet another advantage of the composite framing member assembly is that predetermined decorative features can be formed into the PVC external portion and into the wooden interior portion as well. These decorative features may be formed into the PVC portion as it is extruded and the decorative feature in the wooden portion may be formed by traditional milling procedures.

After the PVC member has been formed and the wooden member has been formed, the members are joined together. To facilitate joining of the two members and to increase the strength of the joint, the PVC member and the wooden member employ corresponding notches at the joining faces of each. These notches form what is known in the art as a tongue-and-groove joint. The PVC member includes the tongue and the wooden member includes the groove. To facilitate the stop and the groove for the weather-strip, the shoulder of the PVC member between the tongue and the stop is recessed a farther distance than is the shoulder on the other side of the tongue. This actually forms a groove in the PVC member such that one of the shoulders surrounding the groove of the wood member functions as a second tongue.

Having this groove in the PVC member deeper into the member provides structural rigidity to the second tongue. The weather-strip groove creates the need for the deeper groove between the tongue and the stop. If the groove for receiving the weather-strip were not present, the stop portion of the PVC member would directly contact the face of the wood member, is thereby providing support. Thus, the deeper groove provides support that would exist but for the presence of the weather-strip groove.

In addition to the tongue-and-groove and stop, the PVC member also includes an elongate sealing grove running from one end of the PVC member to the other. This groove is essentially a triangular groove formed in the PVC member cross section. The groove allows caulk or other sealing material to be concealed from view and isolated from the weather elements. In addition, the triangular groove facilitates nailing a nail into one side of the triangular groove though a portion of the PVC member cross section and into the tongue of the wood member.

Although the preferred embodiment of the present invention comprises a first elongate member joined to a second elongate member, other configurations may be manufactured as well. For example, more than one wooden member may be used for the interior portion. This allows for various decorative features to be included that may be difficult to mill into a single wooden member, or allows for the use of different types of wood. Furthermore, although an almost infinite range of cross sectional shapes is available from the extrusion process, it may be desirable to attach other decorative moldings to the exterior of the assembly. In addition, some decorative features may be formed into the PVC member after it has been extruded.

Not only does the composite framing assembly meet needs felt in the art but not taught in the references, it is also formed in a manner not shown in the references. To form the assembly, the PVC member is extruded by an extruding process known in the art. Next, the wood member is milled from a lumber board to incorporate the various shapes described above, and any other decorative shape that may be desirable. After the two separate members have been manufactured, an adhesive is applied to the joining surfaces and the members are joined together along the joining surfaces. Then, the joined assembly may be heated to accelerate curing of the adhesive. Then, after the adhesive has cured, members may be nailed together to increase structural rigidity.

Generally described, the present invention is a composite framing member assembly including a first elongate member having a cross section, the elongate member extending from a first end to a second end, the first member further defining a first edge and a second edge, and a first face and a second face, the edges and faces extending from the first end to the second end; and a second elongate member having a cross section extending from a first end to a second end, the second member further defining a first edge and a second edge, and a first face and a second face, the edges and faces extending from the first end to the second end, the first edge of the second member adapted to mate with the first edge of the first member such that the first and second members are capable of being joined to each other along the first edge of each member.

Each of the separate members may include formed decorative features.

The first member of the assembly may be made of weather resistant material such as foamed PVC.

The first face of the first member may also define a first elongate groove, the groove extending from the first end to the second end.

In addition, the first edge of the first member may further comprise an elongate first tongue disposed thereupon, projecting above and between a first elongate shoulder and a second elongate shoulder.

The first edge of the second member may also define a second groove disposed between a third shoulder and a fourth shoulder, whereby the second groove is adapted to receive the first tongue disposed between the first shoulder and second shoulder of the first member.

The framing member also may feature a stop having a stop shoulder where the cross sectional width of first edge of the first member is greater than the cross sectional width of the first edge of the second member.

To facilitate receiving a weather-strip, the portion of the first edge of the first member that forms a stop may further define a fifth shoulder having a depth intermediate to the depth of the second shoulder and the stop shoulder.

To increase structural rigidity, the second shoulder may be recessed below the first tongue a depth greater than the depth of the first shoulder.

The present invention also includes a method for forming the composite framing member assembly. This method comprises the step of extruding a first member, wherein the first member has a cross section extending from a first end to a second end and the step of forming a second member, the second member being elongate with cross section extending from a first end to a second end, the cross section of the second member adapted to mate with the cross section of the first member. In addition, the invention may comprise the step of applying an adhesive along the mating surfaces of the first member and second member and joining the first member to the second member at the mating surfaces.

Moreover, the first member may be extruded from a material such as foamed PVC. Furthermore, the method may include the step of heating the first member and the second member after they are joined together to facilitate curing of the adhesive. Finally, the method may comprise the step of nailing the second member to the first member.

### BRIEF DESCRIPTION OF THE DRAWINGS

FIG. 1 Illustrates a cross sectional view of a composite climate seal frame member assembly.

FIG. 1A Illustrates an elevation view of the top portion of the composite climate seal frame member assembly.

FIG. 2 Illustrates a cross sectional view of a first member of a Climate Seal frame member.

FIG. 3 Illustrates a cross sectional view of a second member of a Climate Seal frame member.

FIG. 4 is a flow diagram illustrating a method for making a climate seal framing member assembly.

### DETAILED DESCRIPTION OF THE PREFERRED EMBODIMENT

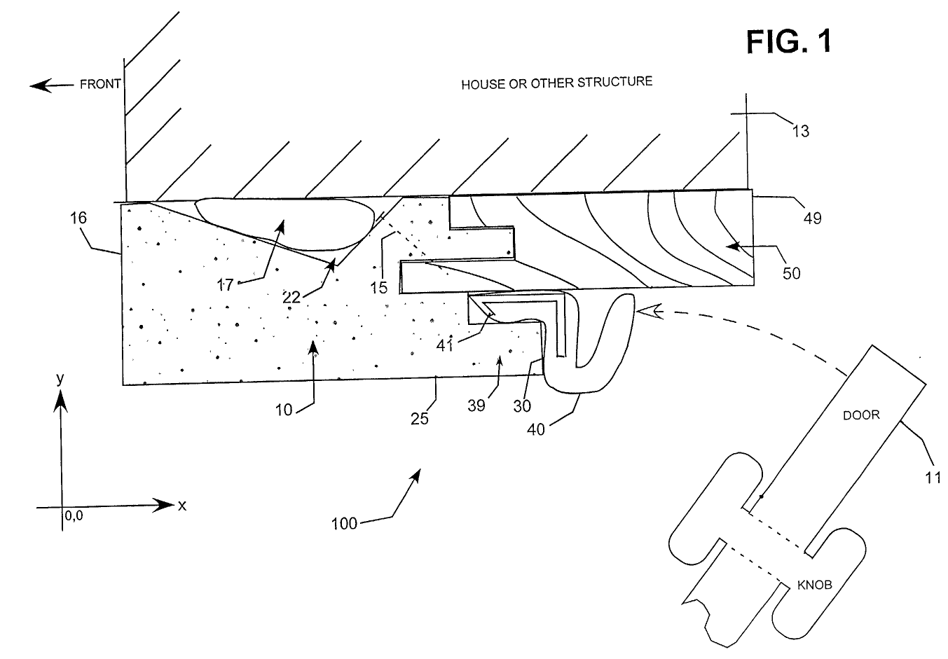

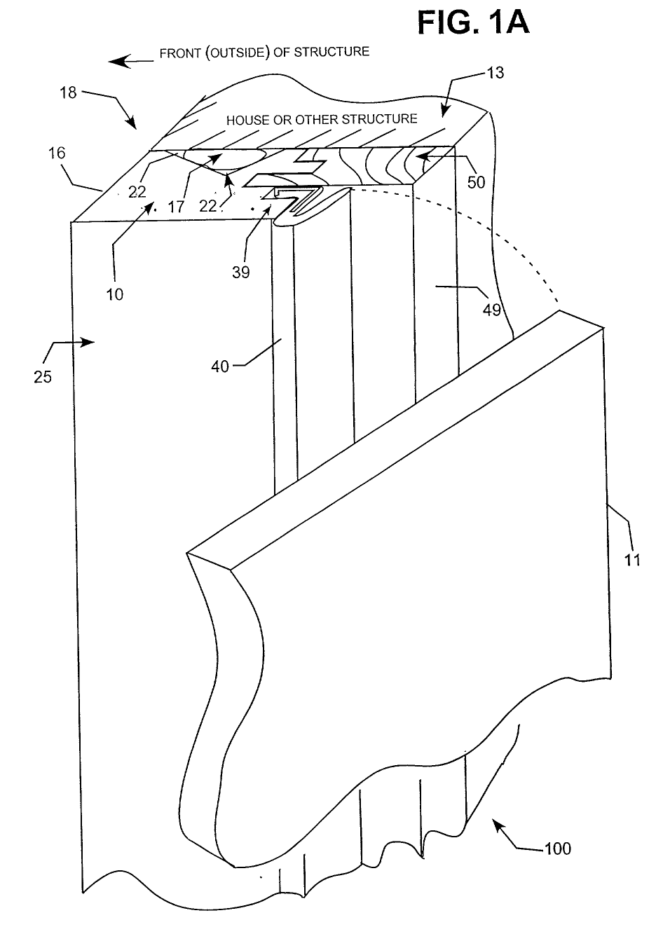

Referring now to the drawings, like numerals indicate like components and elements throughout the several drawing figures. In addition, a legend inset on each of FIGS. 1-3 indicates a Cartesian coordinate system that is used as a reference in describing the preferred embodiment of the invention.

FIG. 1 illustrates a cross sectional view of a climate seal frame member system assembly 100. The assembly 100 combines the benefits of resisting weather and other outdoor elements, such as sunlight and insects, with the appearance of traditional natural wood visible from the interior of a building in which the assembly is installed. The assembly 100 is designed primarily for use in framing a door 11 that provides ingress/egress between the indoors and the outdoors of a residential home. However, the assembly is also useful for framing windows and other openings, and these benefits find use as well in commercial installations.

The assembly 100 includes two separate members that are joined together to form a single member that is capable of being cut and machined at a job site as if it were a traditional one-piece milled framing member. The assembly includes a first extruded PVC member 10 that is joined to a second wooden member 50. The PVC member 10 may be thought of as an elongate member having an essentially rectangular cross section, with various patterns carved into the sides of the rectangular cross section. These patterns are uniform and extend from one end of the first PVC member 10 to the other.

The second member 50 is an elongate wood member that also may be thought of as having a rectangular cross section with patterns carved into the sides that extend from one end of the member to the other. The width, parallel to the y axis of the Cartesian plane, of the first member 10 cross section exceeds the width of the cross section of the second member 50 to form a stop 39, which includes stop shoulder 30. The stop 39 prevents movement of the door 11 past the closed position.

When the door 11 is in the closed position against stop 39, a weather-strip 40 between the door and the stop 39 seals the outdoor elements from the indoors and from the wooden second member 50. A typical weather-strip 40 may be fashioned from rubber or weather resistant, durable material. The weather-strip 40 will typically have a mounting flange 41 that extends along the length of the weather-strip.

In addition, caulk or other sealing material 17 may be used to provide a seal between the framing assembly 100 and the structure 13. This sealing material 17 fits into a first groove 22 and is used to prevent moisture from entering and becoming trapped between the assembly 100 and the structure 13 to which it mounts.

Since groove 22 faces the exterior siding or masonry of the structure 13 to which the assembly 100 is installed, the groove and sealing material are not visible after the assembly has been installed. Thus, the sealing function is accomplished, yet the sealing mechanism is hidden from view. This is advantageous over a traditional doorframe installation in which a caulk bead is typically installed where the framing member meets the siding or masonry such that the caulk bead is visible to someone entering the structure through the doorway. Thus, the present invention improves the visual impact of the doorframe assembly.

Edge 16 as well as face 25 of the first PVC member 10 may contain decorative features formed thereupon. In addition, edge 49 of the second wooden member 50 may contain decorative features formed thereupon. These features may include various shapes that modify the basic cross section of each of the members. Although the decorative features do not increase the weather resistance or the strength of the joint, forming decorative features into the PVC member eliminates a manufacturing step because an additional decorative member need not be formed and attached, as in a traditional milled wooden door frame.

FIG. 1A illustrates an elevation view of the assembly 100, which is shown as a cross section view in FIG. 1. FIG. 1A shows as an isometric view the top 18 of a vertical jamb into which a door closes. It will be appreciated that a horizontal frame member will also typically be installed at the top 18 of the illustrated jamb and span the door opening to the opposite jamb to which the door's hinges are mounted. The horizontal member will typically use a length of the composite assembly 100 and will be joined to the illustrated jamb at the top 19 with a miter joint. Such an installation and method of construction is typical and known in the art.

FIG. 1A shows the first PVC member 10 and the second wooden member 50. Edges 16 and 25 of the first PVC member 10 may include decorative features and edge 49 of the second wooden member 50 may also include decorative features. Weather-strip 40 is shown against stop 39. When the door is in the closed position, the door contacts the weather-strip 40 and the stop 39 limits or “stops” movement of the door. Groove 22 is shown with sealing material 17. Sealing material 17 prevents moisture from reaching the second wooden member 50 and is concealed from view in groove 22. The sealing material may be materials such as caulk, rubber sealing strip, etc. Since sealing material 17 is retained in groove 22, it is shielded from the damaging effects of the sun's ultraviolet rays. Whatever material is used as sealing material 17, it is less likely to shrink, crack, or dry. Thus, the groove 22 provides aesthetic as well as functional benefits.

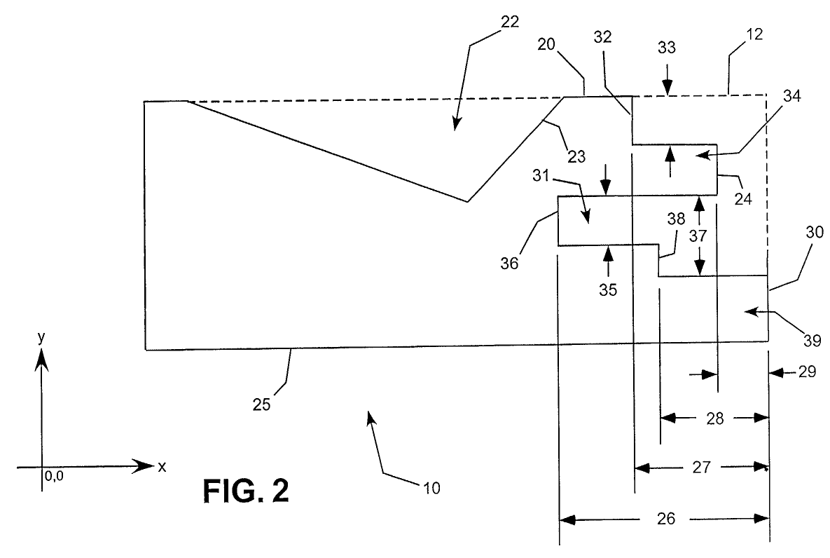

Turning now to FIG. 2, the first PVC member 10 is illustrated in the figure. The first PVC member 10 includes an elongate member that may be viewed as beginning with a solid rectangular cross section 12. Viewing the first PVC member 10 as having a rectangular cross section facilitates describing variations in the shape of the cross section that deviate from the basic rectangular shape. Although it is helpful to view the first PVC member 10 as beginning as a cross section having a basic rectangular shape, the preferred embodiment actually has a cross section having a shape more complex than a simple rectangle. Thus, the dashed lines indicate portions of the rectangular cross section 12 that deviate from a rectangle.

Although a rectangular cross section could provide resistance to environmental factors, and be capable of mating to a similarly rectangular wood member that provides interior aesthetics, the more complex cross section provides benefits over a simple rectangular cross section. One of the long sides of the cross section of the first PVC member 10 is the face 20 that contacts the exterior siding or masonry of a structure. In the preferred embodiment, the face 20 defines a first groove 22 that extends from one end of the member to the other. The groove is formed such that the inclination angle of wall 23 of the groove facilitates nailing one or more nails 15, shown in FIG. 1, through the first PVC member 10 along its length to attach it to the wood member 50.

In addition to the groove 22, other shapes are formed into the first PVC member 10. A first tongue 34 is formed at depth 29 into cross section 12. This increases the stability of a joint between the first PVC member 10 and the second wood member 50. The first tongue 34 is formed such that it is flanked by first shoulder 32 and second shoulder 36. Dimensions 27 and 26 indicate the respective depths of the shoulders, measured in the x direction relative to stop shoulder 30 of stop 39, respectively.

The more shallow depth 27 of first shoulder 32 allows enough material to remain between wall 23 and first tongue 34 to prevent a concentration of stress below the tongue. In addition, this provides sufficient material for receiving a nail or nails that may be used to attach the first member 10 to the second member 50.

As with depth 27, the greater depth 26 of second shoulder 36 accomplishes multiple functions. First, the depth 26 of second shoulder 36 is designed such that sufficient material exists between wall 23 and the second shoulder. Material between wall 23 and second shoulder 36 resists twisting force applied to first PVC member 10 with respect to second wood member 50.

Furthermore, the increased depth 26 of second shoulder 36 places second wood member 50 closer to wall 23 so that a nail or nails 15, shown in FIG. 1, can be nailed into wall 23 farther from face 20. Such a placement of nail or nails 15 tends to increase the strength of the nail attachment.

And, the greater depth 26 of second shoulder 36 provides more bonding surface area for an adhesive that may be applied along tongue 34 to bond first PVC member 10 to second wood member 50.

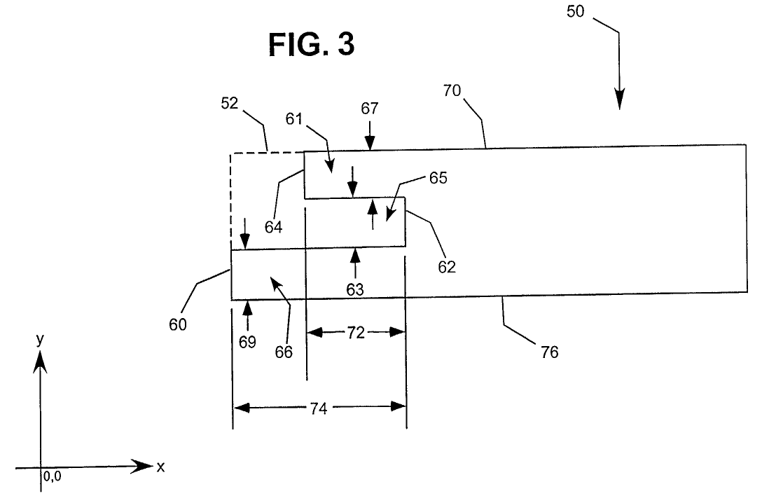

Finally, third groove 31 (third vis-á-vis second groove shown in FIG. 3) extends from second shoulder 36 in the x direction. Third groove 31 is designed to receive second wood member 50.

Other than shoulders 32 and 36 that flank first tongue 34, fifth shoulder 38 (fifth vis-á-vis third and fourth shoulders shown later in FIG. 3) and stop 39 provide additional functionality. Stop 39 provides a door stop function that prevents a door mounted into a frame fashioned from the framing system 100 from continuing to move past its full closed position (see FIG. 1).

Intermediate to the depth of the second shoulder 36 and stop shoulder 30, fifth shoulder 38 provides clearance between the stop and second wood member 50, which is received into third groove 31. This clearance allows installation of weather-strip 40 as shown in FIG. 1. Thus, the clearance that corresponds to shoulder 38 facilitates the receiving of flange 41 of weather-strip 40. It will be appreciated that the depth 28 of shoulder 38 is not critical, but should be deep enough to accept the flange 41 of commercially available weather-strips 40 such that the weather-strip lies substantially flush against stop shoulder 30. However, the depth 28 of shoulder 38 should not be so great so as to weaken support of the second wood member 50, which is received into groove 31.

Turning now to FIG. 3, similar to first PVC member 10 above, the second wood member 50 may be conceptually thought of as originating as a elongate member having a rectangular cross section 52. Likewise, the dashed lines of cross section 52 similarly indicate where material has been removed in the preferred embodiment to create features that increase functionality of second wood member 50 over a member having a purely rectangular cross section.

Second wood member 50 includes a face 70 that abuts the structure into which the assembly 100 is installed. Since the second wood member 50 is intended to be isolated from environmental elements, face 70 will likely be installed such that it mates against another wooden member of structure 13 that was installed during the carpentry stage of construction.

In the preferred embodiment, the cross section 52 includes certain shapes that mate with complimentarily corresponding features of cross section 12 defined by first PVC member 10, as shown in FIG. 2. Thus, the depths in the x direction of second tongue 61, third tongue 66, and second groove 65 are formed so that surfaces 64, 62, and 60 substantially contact surfaces 32, 24, and 36 as shown in FIG. 2 respectively.

However, natural irregularities of wood, such as grain and porosity of cellulose fibers allow adhesive material applied to the surfaces to remain in the joint and bond the members together, rather than being forced out when the members are joined. Thus, the interlocking tongue-and-groove joint retains the benefit of a press fit mating of the tongue 34 into the groove 65, while also benefiting from adhesive material in the joint. In addition, manufacturing variations in the separate members may create voids between the two members when they are joined together. Adhesive applied to the joint surfaces before joining counteracts the reduction in contacting surfaces, thereby ensuring that the members are securely joined.

Furthermore, the widths in the y direction of tongues 61 and 66, surface 62 and associated second groove 65, are fashioned so that surfaces 64, 62, and 60 contact surfaces 32, 24, and 36 respectively as shown in FIG. 2. Thus, dimension 74 equals dimension 26 minus dimension 29 as shown in FIG. 2. And, dimension 72 equals dimension 27 minus dimension 29 as shown in FIG. 2.

When these general guidelines are adhered to, a slight press fit of first tongue 34, shown in FIG. 2, into second groove 65 preferably results. And, a slight press fit preferably results between third tongue 66 and third groove 31 shown in FIG. 2. Such a joint between first PVC member 10 and second wood member 50 is known in the art as a “tongue-and-groove” joint.

A tongue-and-groove joint is desirable because the interlocking geometry of the joint prevents separation between the first PVC member 10 and the second wood member 50 in the y direction. Furthermore, the press fit of the joint enhances stability with respect to any twisting force in the x-y plane that may occur between the first PVC member 10 and the second wood member 50. Moreover, the press fit provides resistance to separation between the two members in the x direction. This resistance may be enhanced by placing an adhesive compatible with PVC and wood materials into grooves 65 (FIG. 3) and 31 (FIG. 2) and onto the tongues 66 (FIG. 3) and 34 (FIG. 2) shown in FIGS. 2 and 3. Thus, the joining of the second wood member 50 to the first PVC member 10 shown (FIG. 2) forms what is for all practical purposes a singular member after the adhesive cures.

Since the assembly 100 is made from more than one member, the cross section of each member will typically be designed to meet various criteria. While the widths and depths of the various tongues and grooves of the first PVC member 10 and the second wood member 50 will typically be similar to the relative dimensions shown in FIGS. 1-3, actual dimensions of these cross sectional portions will typically be chosen to meet certain needs of a particular installation.

For example, the width of the stop 39 shown in FIGS. 1, 1A, and 2 may vary depending upon the thickness of a door used with assembly 100. And, the cross section 12 shown in FIG. 2 and the cross section 52 shown in FIG. 3 may vary depending upon the size of the door and the opening in which it is to be used. Similarly, the width in the y direction of shoulder 38 shown in FIG. 2 may vary depending upon the size of flange 41 of weather-strip 40 shown in FIG. 1. Thus, while the general relationship of the various components of the assembly 100 should be adhered to in order to achieve maximum performance of the assembly, the illustrations of FIGS. 1, 1A, 2, and 3 are not necessarily drawn to scale.

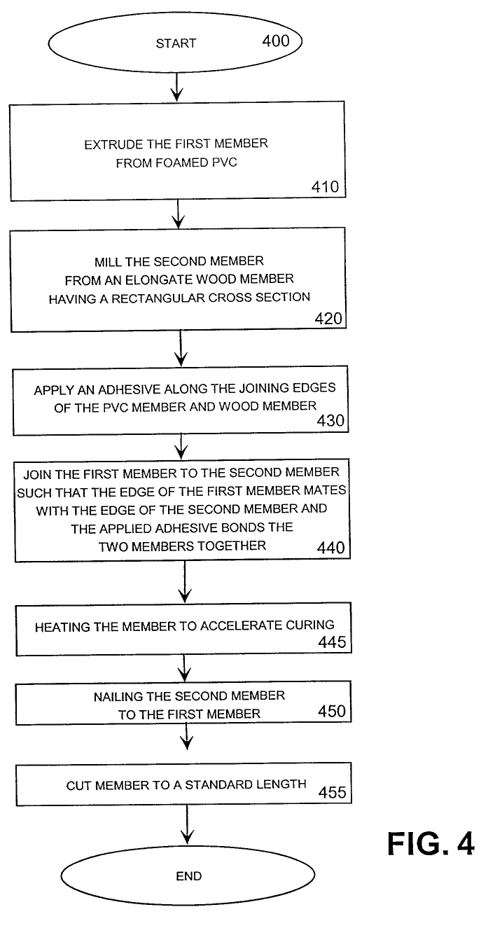

Now that the assembly 100 and its individual components have been described, the discussion turns to FIG. 4. FIG. 4 illustrates a method for making the climate seal framing member system. The process begins at step 400. At step 410 the first PVC member 10 is extruded by an extrusion process that results in the elongate PVC member having a cross section of the desired shape and dimensions. The extrusion process may be any such process known to those skilled in the art.

After extruding the first PVC member 10, the second wood member 50 is formed at step 420 using traditional milling methods known to those skilled in the art. The second wood member 50 should be formed so that cross section 12 mates with cross section 52 of the PVC member 10 such that the tongue and groove joint is a slight press fit as described above. A press fit of these components is desired to provide stability and to maximize the surface area to which the various shapes that contact one another, thereby minimizing regions where contact is not made between the various shapes.

After the PVC member 10 has been extruded and the wood member 50 milled, an adhesive is applied along the mating edges at step 430. The type of adhesive selected is not critical, but should be of a type that is capable of bonding the material of the PVC member 10 to the material of the wood member 50. After the adhesive has been applied at step 430, the two members are joined to one another at step 440. The members are joined along the shaped edges of each member such that the first tongue 34 of the PVC member 10 fits into the third groove 65. At step 445, heat may be applied to increase the speed at which the adhesive cures and bonds the two members.

Finally, after the adhesive has cured at step 445, one or more nails 15 are nailed at step 450 into wall 23 such that they pass into the projection of third tongue 66 of wood member 50. The plurality of nails 15 are preferably evenly spaced along the length of the elongate frame member assembly 100 at a preferable distance of approximately five inches. The spacing of the nails 15 is not critical and may be adjusted as desired for a particular application.

After the PVC member 10 and the wood member 50 have been nailed together, the assembly may be cut to a standard length at step 455. Then, the process is complete. It will be appreciated that the PVC member 10 may be extruded to any length desired and cut to match the length of the wood member 50. Since the second wood member 50 will likely be milled from a piece of lumber having a standard length, the PVC member 10 may be cut to match the length of the wood member 50 before the joining step 440. However, the two members may be joined together even if they are of different lengths. If this scenario occurs, the framing member assembly 100 may be cut at step 455 after the joining 440 and nailing 450 steps to ensure that the length of each member of the assembly is the same length.

In view of the foregoing, it will be appreciated that the invention provides an advantageous climate seal frame member assembly and method for manufacturing. It should be understood that the foregoing relates only to the illustrated embodiments of the invention, and that numerous changes may be made therein without departing from the spirit and scope of the invention as defined by the following claims.

What is claimed is:

1. A composite framing member assembly comprising:
a first elongate member formed from a substantially rigid weather resistant material extending from a first end to a second end, the first elongate member having a cross section that defines a first edge, the first edge further defining a part of an interlocking joint; and
a second elongate member formed from a substantially rigid material extending from a first end to a second end, the second elongate member having a cross section that defines a first edge, the first edge of the second member further defining a counterpart of the interlocking joint wherein the first edge of the second member corresponds to the first edge of the first member such that the first and second members join each other along the interlocking joint.

2. The assembly of claim 1 wherein the cross section of the first member includes a second edge that defines decorative features.

3. The assembly of claim 1 wherein the cross section of the first member includes a second face that defines decorative features.

4. The assembly of claim 1 wherein the cross section of the second member includes a second edge and a second face that defines decorative features.

5. The assembly of claim 1 wherein the first member is formed from foamed PVC.

6. The assembly of claim 1, wherein the cross section of the first member includes a first face that defines a first elongate sealing groove, the sealing groove extending from the first end to the second end.

7. The assembly of claim 1 wherein the part of the interlocking joint includes an elongate first tongue that projects above and between a first elongate shoulder and a second elongate shoulder.

8. The assembly of claim 7 wherein the counterpart of the interlocking joint includes a second groove disposed between a third shoulder and a fourth shoulder, whereby the second groove corresponds to the first tongue of the first member.

9. The assembly of claim 1 wherein the cross sectional width of first edge of the first member is greater than the cross sectional width of the first edge of the second member, such that the portion of the first edge of the first member that exceeds the width of the first edge of the second member forms a stop.

10. The assembly of claim 9 wherein the portion of the first edge of the first member that forms a stop further defines a fifth shoulder having a depth intermediate to the depth of the second shoulder and the extent of the stop.

11. The assembly of claim 8 wherein the second shoulder is recessed below the first tongue a depth greater than the depth of the first shoulder.

12. A composite framing member assembly comprising:
a first elongate member formed from foamed PVC extending from a first end to a second end, the first elongate member having a cross section that defines a first edge and a first face, wherein the first edge of the first member further comprises an elongate first tongue, projecting above and between a first elongate shoulder and a second elongate shoulder to form a part of an interlocking joint, and wherein the first face of the first member further defines a first elongate sealing groove; and
a second elongate member formed from wood extending from a first end to a second end, the second elongate member having a cross section that defines a first edge, wherein the first edge of the second member defines a second groove disposed between a third shoulder and a fourth shoulder and wherein the first edge of the second member corresponds to the first edge of the first member to form a counterpart of the interlocking joint such that the first and second members join each other along the interlocking joint.

13. The assembly of claim 12 wherein the first member further comprises a second edge and a second face that define decorative features.

14. The assembly of claim 12 wherein the second member further comprises a second edge that defines decorative features.

15. The assembly of claim 12 wherein the cross sectional width of first edge of the first member is greater than the cross sectional width of the first edge of the second member, such that the portion of the first edge of the first member that exceeds the width of the first edge of the second member forms a stop.

16. The assembly of claim 15 wherein the portion of the first edge of the first member that forms a stop further defines a fifth shoulder having a depth intermediate to the depth of the second shoulder and the extent of the stop.

17. The assembly of claim 12 wherein the second shoulder is recessed below the first tongue a depth greater than the depth of the first shoulder.

18. A method for forming a composite framing member assembly comprising the steps of:
extruding a substantially rigid first member from a weather resistant material, the first member having a cross section that defines a first face and a first edge extending from a first end to a second end, wherein the first edge defines a part of an interlocking joint;
forming a second member from a substantially rigid material, the second member having a cross section that defines a first edge extending from a first end to a second end, wherein the first edge of the second member defines a counterpart of the interlocking joint; and
joining the first member to the second member along the interlocking joint.

19. The method of claim 18 wherein the first member is formed from foamed PVC.

20. The method of claim 18 further comprising the step of applying an adhesive along the corresponding edges of the first member and second member before the step of joining the first member to the second member.

21. The method of claim 20 wherein the first member and the second member are heated after they are joined together to facilitate curing of the adhesive.

22. The method of claim 18 further comprising the step of nailing the second member to the first member after the step of joining the first member to the second member.
